(19) United States
(12) Patent Application Publication
(10) Pub. No.: US 2008/0250108 A1
(43) Pub. Date: Oct. 9, 2008

(54) Web and telephony interaction system and method

(75) Inventor: Oren Levy, Tel-Aviv (IL)

Correspondence Address: Martin D. Moynihan;PRTSI, Inc., P.O. Box 16446, Arlington, VA, 22215, US

(73) Assignee: blogTV.com Ltd., Ramat-Gan (IL)

(21) Appl. No.: 11/783,366

(22) Filed: Apr. 9, 2007

(51) Int. Cl. G06F 15/16; G06F 3/00

(52) U.S. Cl. 709/206; 715/753

(57) ABSTRACT

Apparatus for location at a website comprising: a media input for receiving a media signal, typically video; a chat room host configured to host chat rooms, each chat room configured to display media from said media input in association with text from chat users as a chat room display; a media output for outputting a media signal; and a user client located between said media input, said media output and said chat room host, configured to provide said media signal to said chat room host, and to receive said chat room display and output said chat room display to said media output as a video signal. The system allows an interactive connection to a mobile telephone and allows a mobile telephone to use its camera to broadcast to all the users of a chatroom.

### FIELD AND BACKGROUND OF THE INVENTION

The present invention relates to a web and telephony interaction system and method and, more particularly, but not exclusively to a system for exchanging video and chat between the World Wide Web and suitably enabled telephony devices.

A new phenomenon on the Internet is the so-called second generation web, or Web 2.0. The original Word Wide Web, or Web 1.0 followed the paradigm of the web as an information source. Web 2.0 is a term used to describe a change in the web paradigm into a collaborative effort, the web as a participation architecture that encourages users to add their own content. Web 2.0 takes advantage of network effects and the participation of users to add value to itself. Key features of Web 2.0 are RSS feeds, blogs, wikis such as wikipedia, and websites that derive their content and functionality through user participation, such as Ebay, YouTube etc.

In its essence, Web 2.0 defines a new type of evolving Internet service that uses the Internet as a whole as a remote software platform that enables tasks that, not so long ago could only be performed on local hardware. These new services use not only the power of remote servers but also harvest the knowledge being created by users for improving the service and generating revenue.

However a limitation of Web 2.0 is that it is primarily computer orientated, and thus stops with the reach of computers. While it is very good at capturing the home and office environments it is less good at capturing the outside world where even the smallest laptops are too bulky or are too limited by their batteries to cover in any comprehensive way.

It has long been possible to use a mobile telephone to provide a photograph or video and to send that photograph or video to an intended destination which may be an email or like address. However there is no provision for Interactive communications between the two.

There is thus a widely recognized need for, and it would be highly advantageous to have, a Web-telephony link devoid of the above limitations.

### SUMMARY OF THE INVENTION

According to one aspect of the present invention there is provided apparatus for location at a website comprising:

a media input for receiving a media signal;

a chat room host configured to host one or more chat rooms, each chat room configured to display media from said media input in association with text from chat users as a chat room display;

a media output for outputting a media signal; and

a text and media mixing unit located between said media output and said chat room host, configured to receive text of said chat room display, mix with said received media signal to form a combined display, and form said combined display into a succession of fixed video frames, thereby to provide to said media output said chatroom display as video.

According to a second aspect of the present invention there is provided a client-supporting telephony device, configured with a user client, the user client operative to configure said telephony device to carry out functions comprising:

connecting to a chat room host,

opening a chat room,

sending a media signal to said chat room to feature on said chat room;

receiving a feedback video signal from said chat room, said feed back video signal comprising a chat room display, and

displaying said chat room display on a screen of said telephone.

According to a third aspect of the present invention there is provided apparatus for interaction between telephone and web, comprising:

a telephony input unit for receiving telephone signals from a first telephone;

a web input unit for receiving a web media signal from a website;

a translating unit for translating said telephone signals for compatibility with said website and for translating said web media signal for sending to a telephone network, such that said first telephone is enabled by said formatting to interact with said web site.

According to a fourth aspect of the present invention there is provided a method for interfacing between a telephone and a web server comprising:

receiving a telephony originated media signal from a first telephone;

receiving a web-originated media signal from a web site;

sending said telephony originated media signal to said web site; and

sending said telephony originated media signal back to said telephone in combination with material added at said web site.

According to a fifth aspect of the present invention there is provided a method for interfacing between a telephone and the world wide web, comprising:

receiving a telephony originated signal from a first telephone;

translating said telephony originated media signal into a web command message for inducing interaction at a web site located on a web server; and

sending said web command message to said web site to induce said interaction; thereby to provide interactive interfacing between a telephone and a web site.

In a system for hosting chat rooms on a web server, each chat room being opened by a first remote user operating a first remote connection, and allowing a plurality of remotely located users including said first remote user to interact via media, said media being combined into a chat room display, at least said first remote user being identified by an identification of said first remote connection and said identification of said first remote connection being used in said opening of said chat room, there is provided an improvement comprising: said first remote connection being a telephony connection and said identification of said first remote connection being an identification of a respective telephone.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram illustrating a web server for supporting telephone to web interactivity according to a first preferred embodiment of the present invention.

FIG. 2 is a schematic diagram showing a typical chat room display with the addition of video from a mobile telephone according to the present embodiments;

FIG. 3 is a schematic diagram of a user client for a mobile telephone according to a preferred embodiment of the present invention.

FIG. 4 is a simplified block diagram of apparatus for placing as a gateway between telephony and IP type networks, according to a preferred embodiment of the present invention.

FIG. 5 is a signal diagram showing the signaling procedure involved in use of the present embodiments.

FIG. 6 is a simplified schematic diagram showing different types of users connected to a web server according to a preferred embodiment of the present invention.

FIG. 7 is a detail of FIG. 5 additionally showing a moderator according to a preferred embodiment of the present invention.

FIG. 8 is a flow chart showing in greater detail the flow outlined in FIG. 5 but from the point of view of the broadcasting user.

### DESCRIPTION OF THE PREFERRED EMBODIMENTS

The present embodiments comprise an apparatus and a method for interactive connections involving the Web and telephony, and apply to media-enabled telephones, particularly but not exclusively cellular telephones. The apparatus comprises a server which supports video download from suitably equipped telephones and uploads web content. In particular the server responds to a call from such a media-enabled telephone by setting up a chat room with free or restricted entry to web users and other telephone users, receives video content from the calling telephone which is displayed in the chat room, and then transmits back to the telephone the chat room text and preferably a split screen showing both the video and the chat room text. Other telephone users are also sent a split screen. However the split screen may be formatted differently for the broadcaster and other telephone users. The broadcaster's interest is in the text and the other users are more interested in the video, so the screens are formatted accordingly. The screens are preferably provided to the telephones via a streaming server associated with the telephone network.

Preferably the format of the feedback is video, and the chat and fed back video are provided and shown as video. Aspects of the invention include the web server that supports the chat room host and is able to receive the video from the telephone and feed back a video screen that includes the originally provided video combined with the chat room texts, that is to say the web server provides back to the telephone the chat room display screen as video. As mentioned the chat room display may also be provided to other telephone users and is typically sent to the users via a streaming server.

A second aspect is the client at the telephone that is able to interact with the web site in order to open a chat room, provide the video content and receive the video of the chat room in return to show on the telephone screen. The client is also able to connect to an existing chat room and retrieve the display for view. The client may also enable text communication with the chat room so that the user can engage in the chat.

A third aspect is a node that links the telephone and web, and in which video in a telephony format, say a format suitable for circuit-switching, is converted into an Internet Protocol suitable format, that is a format suitable for packet switching, and more particularly a format suitable for the web. In the other direction the chat room display, also as video, is converted from the packet switched web format to a format suitable for a telephone connection. The converted format may be forwarded to the streaming server referred to above.

The result is an Interactive connection between the telephone user wishing to broadcast and any number of web users and other telephone users. The connection allows the mobile telephone to provide real time content for the Web and to receive feedback, also in real time. A mobile telephone subscriber who suddenly finds himself in a newsworthy situation is able to broadcast to the web and furthermore to read viewers reactions and thus respond thereto. The user is able to remain online wherever he is located and the web is now receptive to raw unedited and unpredictable user generated content.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

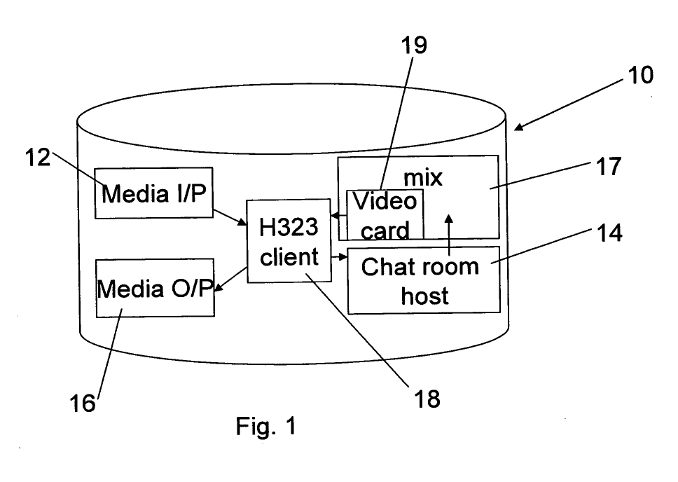

Reference is now made to FIG. 1 which illustrates a web server with suitable apparatus for supporting telephone to web interactivity according to a first preferred embodiment of the present invention. FIG. 1 shows a web server 10 that includes a media input 12 for receiving a media signal, typically a video signal, that originates with a media enabled telephone, typically but not necessarily a mobile telephone. A web server is in the broadest sense a server that is connected to the Internet backbone and stores and makes available web pages, including any interactive functionality in the pages, to Internet users. According to the present embodiments such a web server makes its content available to web users but additionally to mobile users.

The server additionally supports a chat room host 14. A chat room host is software that allows text message conversations to be set up between multiple users. Each multiple user conversation is a room and the rooms may be defined in advance or users may be able to set up their own rooms on demand. In the known art, rooms often center around a video feed, typically from a webcam of a user who has set up the room. In the present invention the chat room host sets up the room around a video feed in the conventional way, but as will be explained below, the video does not come from a webcam, or indeed from the web at all. Rather the video comes from the media-enabled telephone referred to above.

A media output 16 outputs a media signal back to the originating telephone, and media client 18 fits between the input 12 and output 16 on the one hand and on the chat room host 14 on the other hand. The media client 18, first of all receives the caller's video and displays it in the chat room. The media client also receives from the mixing unit 17 a video feed of the text and display from the chat room and sends this to the output for passing to the calling telephone and to any other telephones that may have joined the chat room. It is noted that the display produced by the mixing unit is a display of the activities of the chat room but it is not the same as the standard chat room display sent to the web.

As will be explained in greater detail below the text from the chat room is received by the mixing unit and lines are numbered. The lines are then cycled through so at a rate determined by the rate at which new text messages are added to the chat room. During rapid input the text is cycled through rapidly. During slow input the text is cycled through more slowly and during very slow input the last ten lines are repeatedly cycled through. The current text together with the current media input is frozen into a series of video frames in video card 19 and it is the resulting video signal that is output, via media output 16 to the telephone network.

The standard chat room display that is output to the web is an active display with features that can be clicked on to produce results, since different parts of the screen are differentiated. The display that is produced via the mixer is merely a video frame and is thus passive, in that there is no differentiation between different areas of the screen.

The media client is typically implemented as an H.323 client. H.323 is an umbrella recommendation from the ITU Telecommunication Standardization Sector (ITU-T), that defines the protocols to provide audio-visual communication sessions on any packet network. It is currently implemented by various Internet real-time applications such as NetMeeting™ and Ekiga™.

It will be appreciated that a chat room has to be initiated by an initiating user. Generally web users have no difficulty in remotely initiating a chat room, and the IP addresses of their connections can be used as an identifier so that the initiating user can be identified and distinguished from the other users during the course of the chat. However, it is usually the user who is the source of the media who will wish to open the chat room, and in the present case the user who is the source of the media is a mobile telephone user, who does not have an IP address. Thus, in the present case the web server is configured to accept an identity of the telephone, for example the telephone number or caller ID, in the cellular case the MSISDN the Mobile Services Integrated Services Digital Number. The identity is used by the chat room host 14 to open a new chat room and identify the initiating user. Then the newly opened chat room is able to utilize video received from the connecting telephone to form the centerpiece of the chat room display. Likewise telephone identities are used to identify other telephone users connecting to the existing chat room.

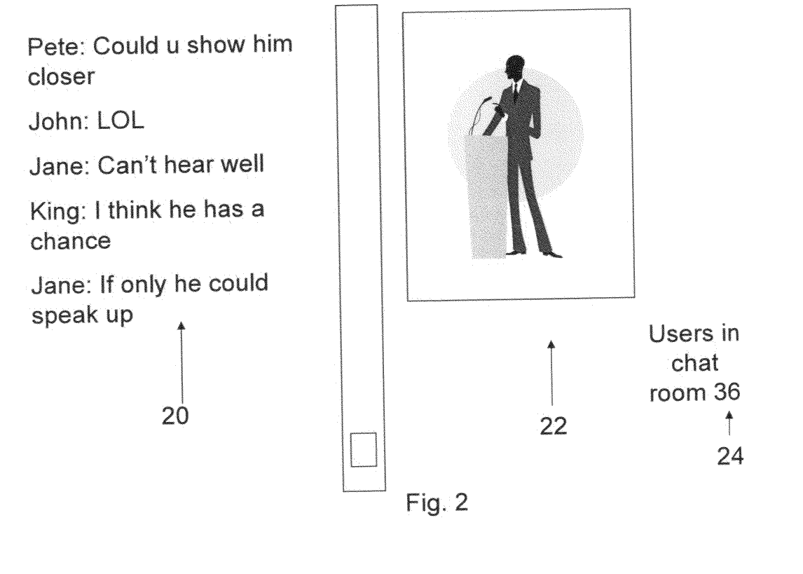

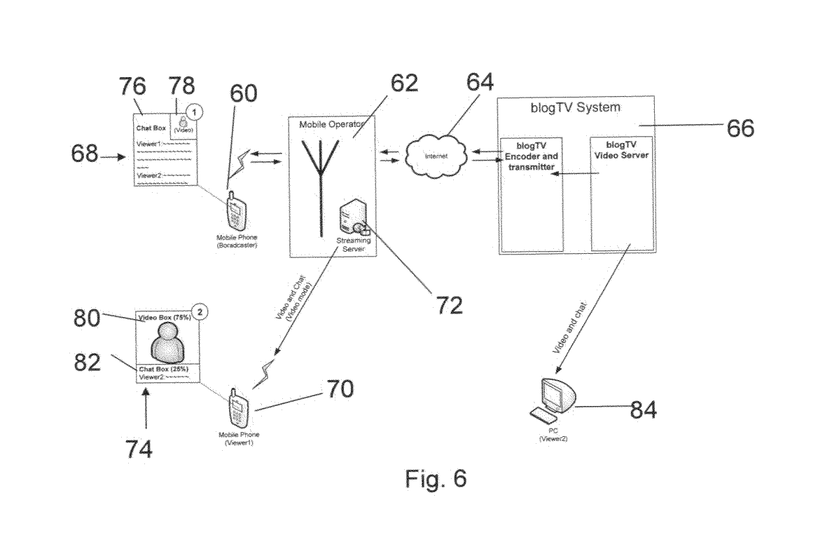

A typical chat room display as may result from use of embodiments of the present invention is shown in FIG. 2. On the left hand side is a column 20 showing a series of succeeding text messages received from users, each identified by a user name. These form the chat. In the upper right hand upper corner 22 is a media frame showing the video sent by the telephone. On the far right 24 is an information column here giving the number of users but which typically lists all the participants. In preferred embodiments the list members can be selected by other users to open sub-chat rooms, so that the individual users can talk to each other privately. The chat room display in FIG. 2 is suitable for web users who generally have relatively large screens. Modifications of the display in FIG. 2 for telephony users who typically have smaller screens are discussed hereinbelow with respect to FIG. 6.

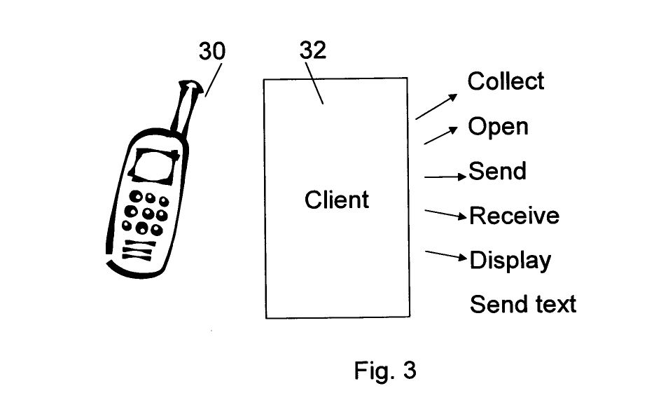

Reference is now made to FIG. 3, which is a simplified diagram illustrating a mobile phone 30 which includes a user client 32 for working with web server 10, according to a preferred embodiment of the present invention. The user client 32 configures the phone 30 in order to connect to the chat room host, and open a chat room as explained using the identity of the telephone. Subsequently the user client configures the phone to send a media signal to the chat room to feature as the media item on the chat room. Typically the media signal is a video feed from a camera included on the telephone, and the client may incorporate camera control features as available. The client also receives a feedback video signal from the chat room, which is typically the screen display shown to all the chat room users, and then the feedback signal is displayed on the screen of the mobile telephone.

Both the initial signal sent to the web server and the returning signal may include voice. Thus the telephone user may speak to his audience, and if desired, receive voice in return, although of course receiving voice in return is less important since he sees their text in any event.

The client preferably also supports making and maintaining a connection to an existing chat room. Again the telephone number or MSISDN may be used as an identity. In such a case the chat room display is also shown on the telephone screen, although, as will be explained below in respect of FIG. 6, the display may be formatted differently than for the broadcasting user.

The client may also support text insertion in a text insertion box, which may then be sent to the chat room as a contribution to the text part of the chat. Typically the text is sent as an SMS.

As mentioned, the telephone need not be a cellular telephone. Any telephone may be used provided that it is media enabled. DECT standard cordless telephones designed for the fixed line telephone networks are examples of non-cellular telephones with media enablement.

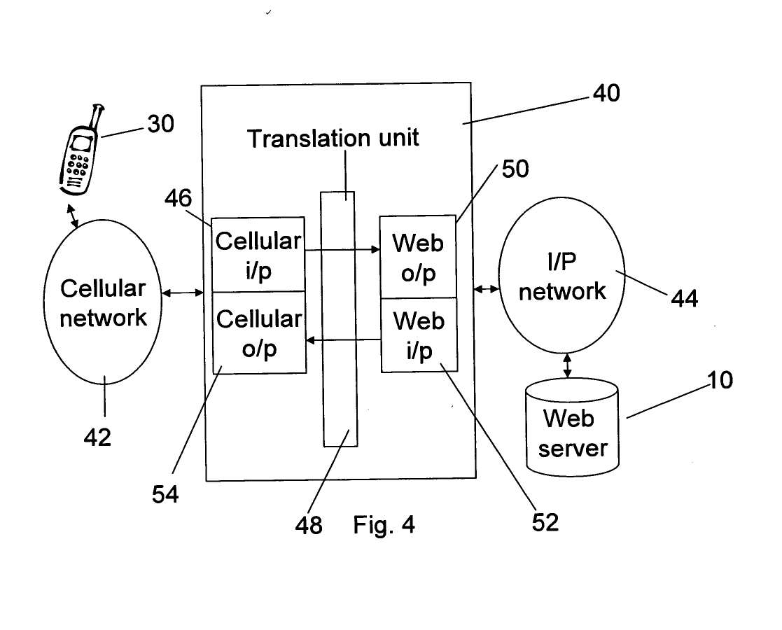

Reference is now made to FIG. 4, which is a simplified block diagram illustrating apparatus 40 for location at a node linking telephony 42 and Internet Protocol 44 networks and which provides for interactive communication between telephone 30 and web server 10 according to a preferred embodiment of the present invention.

The apparatus comprises a telephony input unit 46 which receives initial connection requests and a telephone media input signal from the telephone 30 via the telephone network 42. The media signal is typically video and is received in a format which is suitable for a telephone network. Telephone networks are typically circuit switched, and so the formats are constructed appropriately. However GPRS (General Packet Radio Service) allows for data packets without circuit switching on cellular networks. The media signal for example could be transmitted by GPRS. A format transform unit 48 then translates the telephony format for the IP network 44 at the other side. Herein the format transform unit is labeled as a packet switched to circuit switched transform unit. However, as mentioned, the transform may be other than circuit to packet switching. The transform unit passes the signal to an output unit 50 for output to the IP-based network 44 and to web server 10.

In the reverse direction a web input unit 52 receives a web media input signal from the web server 10. The web signal is transformed by the transform unit 48 from a form suitable for the Internet to a form suitable for the telephony network, following which it is output to the telephony network via output 54. The result is that in the first direction, the telephone user is able to set up a new chat room or connect to an existing chat room and make the telephone media available to surfers at the new chat room. In the other direction the display output of the chat room, and possibly also any audio output is available to telephones.

In the following an embodiment of the present invention referred to as Mobile to BlogTV is described.

The Mobile to blogTV embodiment encompasses live broadcasts that can be made using a mobile phone video camera and shown to any web user who chooses to connect to the resulting chat room. The Broadcast is achieved by making a simple video call to the blogTV phone number.

As explained, the viewers are able to watch the broadcast, no matter where in the world the broadcaster is, and talk to him using a simple web chat interface. The broadcaster sees both the chat conversation and the video he is broadcasting on his mobile phone screen. The Broadcast can thus be seen by both users on the web site and by mobile telephone users.

The present embodiments permit the broadcaster to see viewer reactions as 5 they are being written.

There is thus provided a new kind of content creation. The content is user generated content, may be generated practically anywhere, and may be broadcast to anyone, live, and unedited, and is thus contextual. The present embodiments empower ordinary people to act as one-to-many journalists on any issue of their choosing, exactly in accordance with the philosophy behind Web 2.0.

The fact that users can broadcast while away from their home/office environment and from their PCs, renders the time, place and situation the main issue of the broadcast, and the broadcaster becomes a middleman or moderator between the viewers and the events.

Thus, the presently described embodiments allow the common person to become a journalist and cover anything he may accidentally or deliberately come across, whether it be breaking news (for example: hurricane Katrina), through important events (such as sports events, parties, etc.), to catching one's favorite celebrity buying his coffee, so that he may update fan club members on the event.

The service also enables users to stay in touch and share their life with friends and family, even from the other side of the world.

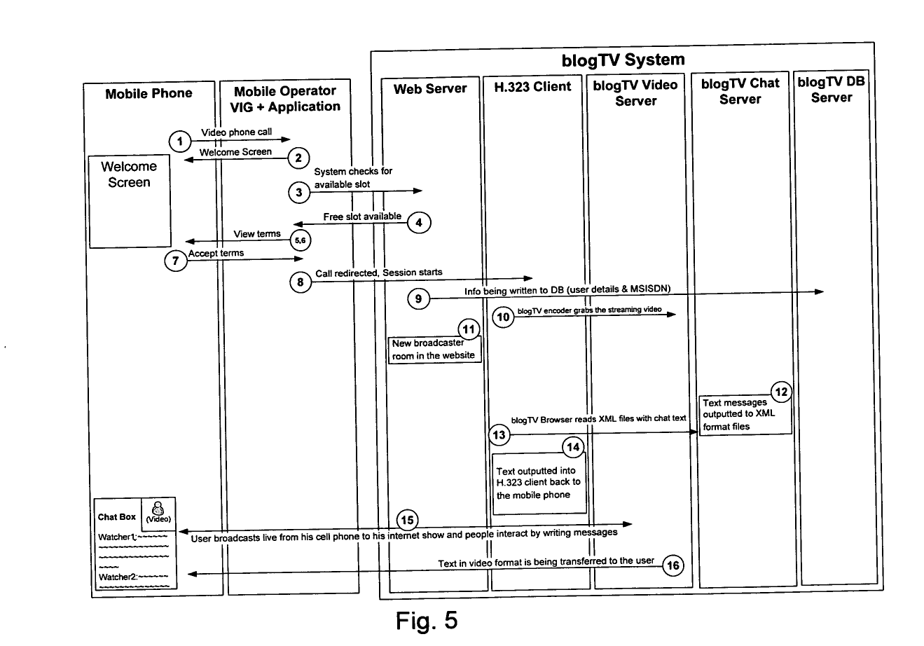

Reference is now made to FIG. 5, which is a simplified signal chart showing signal flow involved in use of the present embodiments.
1. The user begins by making a video call using his mobile phone to a predefined phone number (or short code number).
2. The user receives a welcome screen that is played from a streaming server.
3. The system then checks to ascertain whether there is a free slot available to host the call.
4. The system replies to the query in 3 that there is a free slot available
5. The user receives an option screen and is prompted to agree or disagree with the terms by pressing a number on his phone. This stage could be dispensed with for recognized users, as desired by the system manager.
6. The user may then choose to view the terms, and agree with the terms or disagree. If the user does not agree to the terms he is promptly disconnected from the system.
7. The user agrees to the terms and receives a message that he is about to broadcast live.
8. The video call is redirected from the operator to the h.323 client and an HTTP request stating that a broadcast session has started is sent from the video gateway 40 described in FIG. 4, also referred to herein as the VIG application, to the blogTV receiver. The request is sent together with the user's MSISDN.
9. The blogTV receiver receives the HTTP request and enters the information about the request together with the user's MSISDN into its database.
10. The blogTV server includes a video encoder unit, The encoder unit is notified that there is a new session and it grabs the video from the h.323 client, encodes it and sends it the blogTV video server.
11. A new broadcast room, that is a chat room with a broadcast video, is opened on the Internet website, and viewers on the web are able to access the broadcast and also use the chat application to write text messages.
12. The text messages that the users write are output to an XML format file. In the XML file each line receives a unique ID, from an auto incrementation function.
13. A blogTV browser connects to the XML file and reads 10 new messages from the last ID it displayed. The text is scrolled down. The speed of the scroll is automatically calculated to be faster or slower according to the number of text messages that still need to be displayed.
14. The scrolling text is output as an analog video feed and connected to a video card on the server that hosts the h.323 client. The video card is configured as the video source in the h.323 client and the video source with the modified scrolling text is relayed to the mobile telephone so that the caller actually receives a video feed of what is going on in the chat room back to his mobile phone, but modified for his needs as a mobile user. The scrolling text feature, using auto increment, speed modification and the ten most recent messages ensures that all messages are shown at least once, and that in the event of few messages, the messages pass more slowly on the screen and are cycled through. While web users are able to use a scroll bar or a cursor to move around the screen, mobile telephone users may lack any direct means of navigating, so managing the scrolling of text is particularly helpful to mobile phone users, who do not have this facility. Even if the mobile telephone user does have some way of moving around his screen, the present display is provided in video format rather than as an active screen so the mobile user is further hampered in self-managing the chat texts.
15. The user continues to broadcast live from anywhere to his show on the Internet and people interact with him by writing him text messages in the chat application.
16. At the same time the user continues to receive the text that the viewers write to his mobile screen. He is able to respond to the text using voice and video.

Reference is now made to FIG. 6, which is a simplified block diagram illustrating an arrangement in which mobile telephone users are both broadcasters and viewers.

In FIG. 6 a first user 60 connects via a mobile telephone, mobile provider 62, the Internet 64 to BlogTV service 66. He sets up a chat room, using his telephone number or MSISDN as an identity and broadcasts. Feedback screen 68 is viewed by the broadcasting user. Mobile user 70 may also connect to the chat room. He is able to download the chat room display via streaming server 72, and he sees screen 74, which is also a screen of the chat room but is preferably formatted differently from the chat room display 68 shown as the broadcaster's feedback screen.

Broadcaster's feedback screen 68 comprises a large text window 76 which displays the text streaming presented in phase 16 of the process workflow above and a small video window 78 where the broadcaster sees his own broadcast.

Screen 74 at the viewer is slightly different. In this case the video is the main feature and is not merely present for self reference as in the case of the broadcaster. The configuration presented to a mobile phone viewer involves 75% of the upper screen showing the Video Box 80 so that the viewer can see the live broadcast. The remaining 25% shows the Chat Box 82 in which chat text can be viewed. The chat text scrolls up and down inside the chat window.

Internet or web user 84 receives the video and chat together as a standard chat room display along the lines shown in FIG. 2.

The present embodiments are provided with API programming features that allow for interactions. Some of the API features are given below:

Disconnect user—the disconnect user API is located on the VIG or interface application 40 and is used by the moderator to disconnect users. The API receives only one parameter, the user's MSISDN. If the MSISDN exists and is currently holding an open session he will be disconnected.

Send Warning—a send warning API is preferably located on the blogTV system 66 and is used by the moderator to warn users that they are misbehaving. In one preferred embodiment once the moderator activates a warning the API is called with two parameters, MSISDN and client ID. The API creates a record in the database with the date and time the API was activated. The blogTV browser queries the database every five seconds and if a warning record exists in the database it replaces the scrolling text with a warning image that notifies the user that if he continues to misbehave he will be blocked and disconnected. After 10 seconds from the date and time the record was created in the database the warning image is replaced with the regular scrolling text

New session—Every time a mobile user calls the system and is transferred to the h.323 client a new session API is called by the VIG application 40. The API is called with the user's MSISDN and status code 0 which means that the broadcast has started. The API inserts into the callers database table a new record with the MSISDN

Session ended—when a mobile user hangs up the call or is disconnected the session ended API is called so that the blogTV encoder stops encoding and sending a blank stream to the blogTV video server.

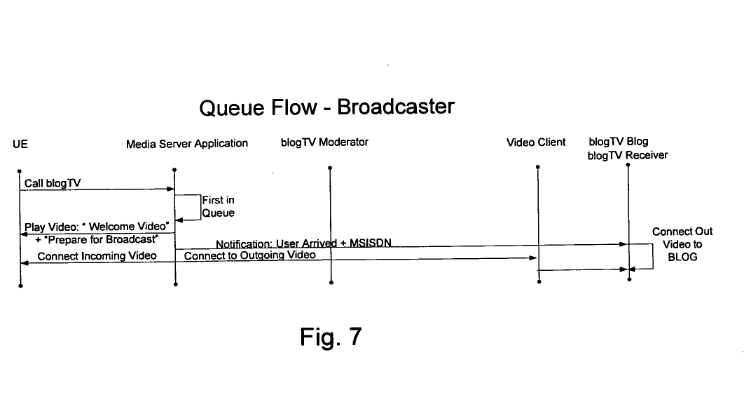

FIG. 7 is a detail of FIG. 5 showing the moderator as a centrally located entity in the signal passing process.

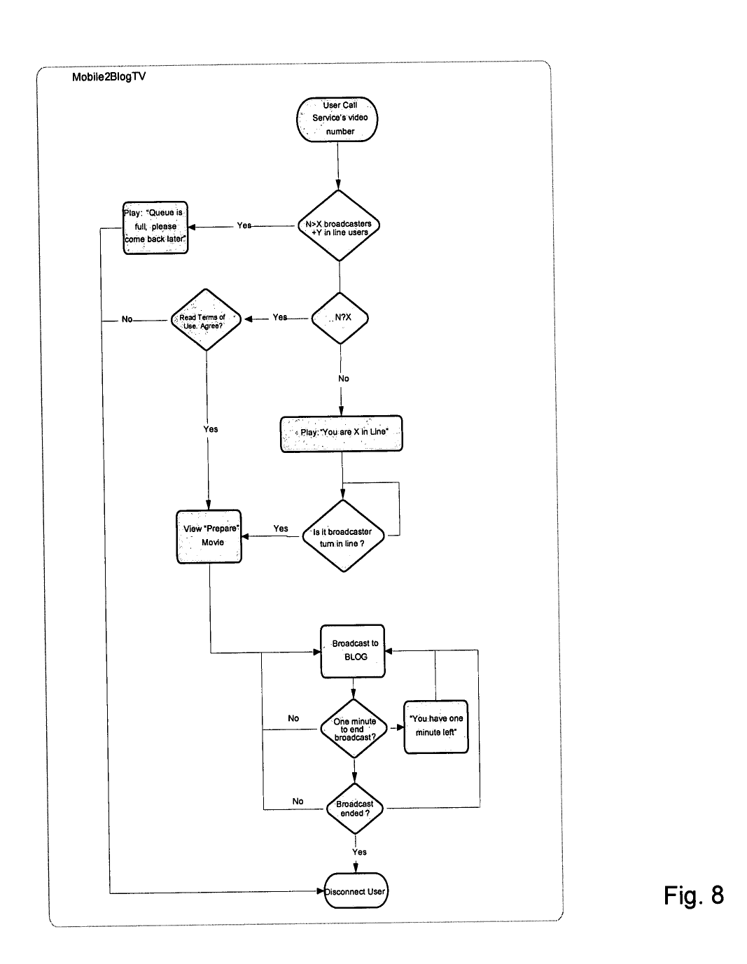

Reference is now made to FIG. 8, which is a simplified flow diagram illustrating the procedure of FIG. 5 from the point of view of the broadcaster and the broadcaster's telephone client. Initially the intended broadcaster places a call. Availability is then tested. If there are no spare slots and the queue is longer than a certain threshold length then the intended broadcaster is told to try again later. If there are no spare slots but the queue is short then the intended broadcaster is asked to wait. If there is a spare slot, or when the spare slot becomes available, then the intended broadcaster is offered the terms of use. If the intended broadcaster agrees then he is told to prepare for live broadcasting. The viewer may be shown a preparation video. The viewer then broadcasts.

A time limit may be placed on the broadcast, for example if resources are scarce and users are many. The user may be given a warning as the time limit approaches and the broadcast is finally ended.

The following is a list of terms used herein with explanations.
1. Mobile phone—refers to any mobile phone that has video call capabilities and can be used as a camera to broadcast live. The user dials a predefined phone number or short code number and selects creation of a video call. More generally any media enabled phone is included even if not a mobile phone.
2. VIG—The Video Interactive Gateway 40 handles the video call and the conversion between circuit switch networks such as telephone networks and packet switch networks such as the internet.
3. H.323 Client—receives the caller's video and displays it in the chat room. The H.323 client also sends to the caller a video feed of the text from the chat room. H.323 is an umbrella recommendation from the ITU Telecommunication Standardization Sector (ITU-T), that defines the protocols o provide audio-visual communication sessions on any packet network. It is currently implemented by various Internet real-time applications such as NetMeeting and Ekiga (the latter using the OpenH323 implementation). It is a part of the H.32x series of protocols which also address communications over Integrated Services Digital Network (ISDN), Public switched telephone network (PSTN) or Signaling System 7 (SS7). H.323 is commonly used in Voice over IP (VoIP, Internet Telephony, or IP Telephony) and Internet Protocol (IP)-based videoconferencing. Its purpose is thus similar to that of the Session Initiation Protocol (SIP).
4. blogTV encoder—grabs the video from the h.323 client and sends it to the blogTV video server.
5. blogTV video server—handles the video stream from the encoder and streams it to viewers on the internet.
6. Chat server—handles and interacts with the site chat clients, receives messages from the clients and manages the shows text content
7. blogTV browser—scrolls the chat text and icons from top to bottom and requests new text information every time the scroll finishes.
8. blogTV receiver—receives all the http requests and enters the information to the database.
9. Moderator admin—is a control panel for moderators where they can view all the live broadcasts and chat text and decide whether to send the broadcaster a warning or disconnect the call.
10. Database—stores all the blogTV information and permits access to the information using queries.

It is expected that during the life of this patent many relevant devices and systems will be developed and the scope of the terms herein, particularly of the terms Internet, cellular network, circuit switched network, packet switched network, media signal, chat, text messaging, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for location at a website comprising:
a media input for receiving a media signal;
a chat room host configured to host one or more chat rooms, each chat room configured to display media from said media input in association with text from chat users as a chat room display;
a media output for outputting a media signal; and
a text and media mixing unit located between said media output and said chat room host, configured to receive text of said chat room display, mix with said received media signal to form a combined display, and form said combined display into a succession of fixed video frames, thereby to provide to said media output said chatroom display as video.

2. Apparatus according to claim 1, further configured to receive an identity of a connecting telephone and to forward said identity to said chat room host to open a new chat room, said new chat room to utilize video received from said connecting telephone to form a respective chat room display.

3. Apparatus according to claim 2, configured to work with a user client of a mobile telephone in order to receive said identity, open said chat room and provide said video signal as feedback.

4. Apparatus according to claim 1, wherein said chat room text is received as a series of lines, said text and media mixing unit being configured to provide each line with a line identity.

5. Apparatus according to claim 4, wherein said text and media mixing unit is configured to mix said received text such that a predetermined number of most recent lines are cycled through.

6. Apparatus according to claim 4, wherein said text and media mixing unit is configured to present said lines at a rate dependent on a current rate of receipt of new text by said chat room.

7. A client-supporting telephony device, configured with a user client, the user client operative to configure said telephony device to carry out functions comprising:
connecting to a chat room host,
opening a chat room,
sending a media signal to said chat room to feature on said chat room;
receiving a feedback video signal from said chat room, said feed back video signal comprising a chat room display, and
displaying said chat room display on a screen of said telephone.

8. The client-supporting telephony device of claim 7, being a cellular telephone.

9. The client-supporting telephony device of claim 7, wherein said user client is further operative to configure said telephone to send text messages to a chat room.

10. The client supporting telephony device of claim 7, wherein said user client is further operative to configure said telephone to connect to an existing chat room.

11. Apparatus for interaction between telephone and web, comprising:
a telephony input unit for receiving telephone signals from a first telephone;
a web input unit for receiving a web media signal from a website;
a translating unit for translating said telephone signals for compatibility with said website and for translating said web media signal for sending to a telephone network, such that said first telephone is enabled by said translating to interact with said web site.

12. Apparatus of claim 11, wherein said telephone signals comprise a predetermined dialed number and said translating comprises translating said number into an HTTP message.

13. Apparatus according to claim 12, wherein said HTTP message comprises an instruction to open a new chat room or enter an existing chat room.

14. Apparatus according to claim 11, wherein said telephone signals comprise a video stream and said translating comprises formatting said video stream for transfer over an IP network to be displayed at said web site.

15. Apparatus according to claim 11, wherein said web media signal comprises a mixture of a previously sent telephony signal and material added at said web site, and said translation unit is configured to translate said mixture for distribution over a telephony network.

16. Apparatus according to claim 11, wherein said web media signal comprises collaborative web input.

17. Apparatus according to claim 16, wherein said collaborative web input comprises a chat stream.

18. Apparatus according to claim 11, wherein said web media signal comprises a succession of video frames.

19. Apparatus according to claim 15, wherein said telephony output unit is configured with a video streaming unit to send said mixture to a plurality of other telephones, and wherein said video streaming unit is configured to stream said mixture in a first format to said first telephone and in a second format to said plurality of other telephones.

20. Apparatus according to claim 11, wherein said translation unit comprises a circuit-switch to packet-switch converter located between respective input and output units to convert between a packet switched format for said web and a circuit-switched format for telephony.

21. Apparatus according to claim 13, wherein said translation unit is configured to include within said HTTP instruction an identity of said telephone in order to open said chat room.

22. Method for interfacing between a telephone and a web server comprising:
receiving a telephony originated media signal from a first telephone;
receiving a web-originated media signal from a web site;
sending said telephony originated media signal to said web site; and
sending said telephony originated media signal back to said telephone in combination with material added at said web site.

23. The method of claim 22, wherein said telephony originated media signal is a video signal.

24. The method of claim 23, wherein said web originated media signal is a signal comprising a collaborative web input.

25. The method of claim 24, wherein said collaborative web input is a web-hosted chat room, and said material added at said web site comprises contributions from a plurality of web users.

26. The method of claim 22, further comprising receiving an identity of said telephone and using said identity to open a chat room at said website, said chat room to feature media content of said telephone.

27. The method of claim 22 further comprising sending said combined signal to a plurality of other telephones.

28. The method of claim 22, wherein signals to and from said telephone are circuit-switched signals and signals to and from said web site are packet switched signals, the method comprising converting said media signals between packet and circuit switched formats.

29. Method for interfacing between a telephone and the world wide web, comprising:
receiving a telephony originated signal from a first telephone;
translating said telephony originated media signal into a web command message for inducing interaction at a web site located on a web server; and
sending said web command message to said web site to induce said interaction; thereby to provide interactive interfacing between a telephone and a web site.

30. In a system for hosting chat rooms on a web server, each chat room being opened by a first remote user operating a first remote connection, and allowing a plurality of remotely located users including said first remote user to interact via media, said media being combined into a chat room display, at least said first remote user being identified by an identification of said first remote connection and said identification of said first remote connection being used in said opening of said chat room, an improvement comprising: said first remote connection being a telephony connection and said identification of said first remote connection being an identification of a respective telephone.

31. The improvement of claim 30, wherein media received from said first remote user comprises video, and wherein media from other remote users comprises text, such that said media combined into said chat room display comprises a combination of text and video.

32. The improvement of claim 31, further comprising an output configured for sending said chat room display to said first remote user via said telephony connection.
